(19) United States
(12) Patent Application Publication
(10) Pub. No.: US 2008/0075323 A1
(43) Pub. Date: Mar. 27, 2008

(54) SYSTEM AND METHOD FOR DISTANCE FUNCTIONALITY

(75) Inventor: Stephan Hartwig, Essen (DE)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/534,775

(22) Filed: Sep. 25, 2006

(51) Int. Cl. G06K 9/00

(52) U.S. Cl. 382/106; 382/107

(57) ABSTRACT

Systems and methods applicable, for example, in distance functionality. A device might, for instance, perform image capture during translocation. Distance between the device and one or more objects might, for example, be determined. Such determination might, for instance, take into account translocation determination regarding one or more of the objects and translocation determination regarding the device.

### FIELD OF INVENTION

This invention relates to systems and methods for distance functionality.

### BACKGROUND INFORMATION

In recent times, there has been an increase in devices (e.g., wireless nodes and/or other computers) including and/or being in communication with capture units. For example, capture units have increasingly become standard device features. Moreover, many users have increasingly come to prefer devices that include, and/or that are in communication with, capture units over those that do not include, and/or that are not in communication with, capture units.

Accordingly, there may be interest in technologies that make use of such capture units.

### SUMMARY OF THE INVENTION

According to embodiments of the present invention, there are provided systems and methods applicable, for example, in distance functionality.

In various embodiments, a device might perform image capture as it translocates (e.g., as it moves laterally). Distance between the device and one or more objects might, in various embodiments, be determined.

Such determination might, in various embodiments, take into account translocation determination regarding one or more of the objects and translocation determination regarding the device.

### BRIEF DESCRIPTION OF THE DRAWINGS

FIG. 1 shows exemplary steps involved in distance determination operations according to various embodiments of the present invention.

FIG. 2 shows an exemplary depiction according to various embodiments of the present invention.

FIG. 3 shows an exemplary display according to various embodiments of the present invention.

FIG. 4 shows exemplary steps involved in distance employment operations according to various embodiments of the present invention.

FIG. 5 shows an exemplary computer.

FIG. 6 shows a further exemplary computer.

### DETAILED DESCRIPTION OF THE INVENTION

### General Operation

According to embodiments of the present invention, there are provided systems and methods applicable, for example, in distance functionality.

In various embodiments, a device might perform image capture during and/or prior to translocation. Determination regarding translocation, as indicated by the image capture, of one or more objects (e.g., translocation of object projections on one or more capture units as indicated by the image capture) might, in various embodiments be performed. Moreover, determination regarding the translocation of the device during image capture might, in various embodiments, be performed. The association between data of one or more motion sensors (e.g., accelerometers) and frames in an image capture sequence might, in various embodiments, be stored.

Distance between the device and one or more of the objects might, in various embodiments, be determined. Such determination might, in various embodiments, take into account the translocation determination regarding one or more of the objects and the translocation determination regarding the device. The determined distance might, in various embodiments, be employed in a number of ways.

Various aspects of the present invention will now be discussed in greater detail.

### Distance Determination Operations

According to various embodiments of the present invention, a device might move. Such movement might, for example, be lateral (e.g., from left to right, and/or from right to left). The movement might, in various embodiments, involve the device panning across a scene (e.g., an outside scene).

The device might, for instance, include and/or be in communication with a capture unit (e.g., a Complementary Metal Oxide Semiconductor (CMOS) and/or Charge Coupled Device (CCD) image capture unit). In various embodiments, the device might be a wireless node and/or other computer.

The device might, for example, move due to action by its user. The device might, in various embodiments, instruct the user (e.g., via a Graphical User Interface (GUI) and/or other interface) to take such action. As another example, the device might move automatically. It is noted that, in various embodiments, such movement and/or user instruction might be subsequent to the user indicating to the device (e.g., via a GUI and/or other interface) that the user desires to learn of one or more distances. It is noted that, in various embodiments, the movement of the device might be a slight movement.

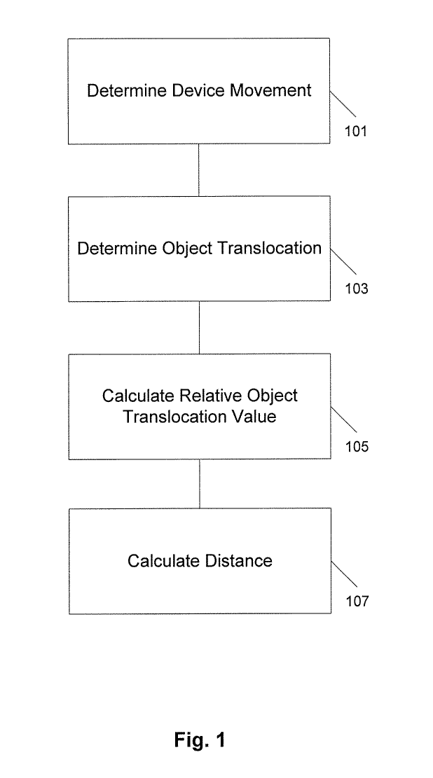

With respect to FIG. 1 it is noted that, according to various embodiments of the present invention, one or more operations might be performed (e.g., by the device) to determine the amount by which the device moves (step 101). Such functionality might, for example, involve the use of one or more motion sensors (e.g., accelerometers). The device might, for example, include and/or be in communication with such accelerometers.

Such an accelerometer might, for example, output the acceleration of the device during the device's movement. In various embodiments, the amount by which the device moves might be computed from this acceleration. For example, double integration and/or iterated integration might be performed on the outputted acceleration. Such iterated integration might, for instance, involve performing integration on the outputted acceleration to yield a speed, and performing integration on that speed to yield a distance.

As another example, the amount by which the device moves might be determined by determining the imaged translocation of one or more reference objects with known distances from one or more capture units. Such might, for instance, be performed in the case where the device lacks an accelerometer.

The device might, in various embodiments, perform image capture as it moves. For example, the device might capture an image periodically. Capture might, for instance, be every x time units, where x is a selected value. As an illustrative example, the device might capture an image every 60^{th} of a second. Capture might, for example, be in accordance with specification by one or more users, manufacturers, system administrators, and/or service providers.

According to various embodiments of the present invention, operations might be performed (e.g., by the device) on captured images. For example, one or more image analysis operations might be performed. Such image analysis operations might, in various embodiments, be with respect to one or more objects in the captured images (e.g., buildings, streetlamps, people, and/or trees in the case of an outside scene).

A number of image analysis operations might be performed. For example, image segmentation, edge recognition, and/or pattern recognition might be performed. It is noted that, in various embodiments, techniques used in motion estimation (e.g., motion estimation for video encoding) might be employed.

In various embodiments, perhaps subsequent to one or more image analysis operations being performed, one or more operations might be performed (e.g., by the device) to determine the translocation, as indicated by the image capture, of those objects (step 103). As an illustrative example, in the case where the device captured a series of images by panning across a scene moving from left to right, the image capture might indicate an object (e.g., a stationary object) included in the captured scene to be translocating from right to left.

Determination of the translocation of one or more objects as indicated by image capture of those objects (e.g., translocation of object projections on one or more capture units as indicated by the image capture) might, for instance, involve determination of the amount of such translocation between captured images. For example, the amount of such translocation between a first captured image (e.g., an image captured with start of movement of the device) and a last captured image (e.g., an image captured with stop of movement of the device) might be determined. As another example, the amount of such translocation between two subsequent captured images (e.g., two subsequent captured images not including a first captured image and/or a last captured image), might, alternately or additionally, be determined. As yet another example, the amount of such translocation between two non-subsequent captured images (e.g., two non-subsequent captured images not including a first captured image and/or a last captured image), might, alternately or additionally, be determined.

Object translocation might, for example, be determined in terms of numbers of pixels. To illustrate by way of example, it might be determined that an object translocated by 100 pixels between two captured images.

As another example, object translocation might be determined in terms of one or more percentages (e.g., one or more percentages of sensor capture dimensions). To illustrate by way of example, it might be determined that, between two captured images, an object translocated two percent of the capture area of a sensor (e.g., in the horizontal dimension).

In various embodiments of the present invention, a relative object translocation value might be calculated (e.g., by the device) (step 105). Such a relative object translocation value might, for example, compare (e.g., via quotient) the number of pixels that an object has translocated to the total number of pixels of the capture unit. The total number of pixels of the capture unit might, for instance, be the total number of pixels in the dimension (e.g., horizontal) in which the object translocated.

To illustrate by way of example, in various embodiments in the case where an object moved, between two captured images, 100 pixels in the horizontal dimension, and the total number of pixels of the capture unit in the horizontal direction was 1000 pixels, the relative object translocation value might be computed as:

number of pixels object moved/total number of pixels=100/1000=0.1

In various embodiments, such a calculated relative object translocation value might be considered to be equivalent to the quotient of the amount by which the device moves and the measure (e.g., in centimeters) of the portion of the object plane of the object that is projected on to the capture unit. Such measure might, in various embodiments be in a dimension in which the object as indicated by image capture moved (e.g., movement of a projection of the object on one or more capture units as indicated by the image capture). Such movement might, for example, be vertical and/or horizontal. The measure might, in various embodiments, be proportional to the distance between the object plane and the capture unit.

Accordingly, for instance, taking d to be the amount by which the device moves and T to be the measure of the portion of the object plane of the object that is projected on to the capture unit, this quotient might be considered to be:

d/T.

Then, taking Δp to be the relative object translocation value, in various embodiments it might be taken to be the case that:

Δp=d/T

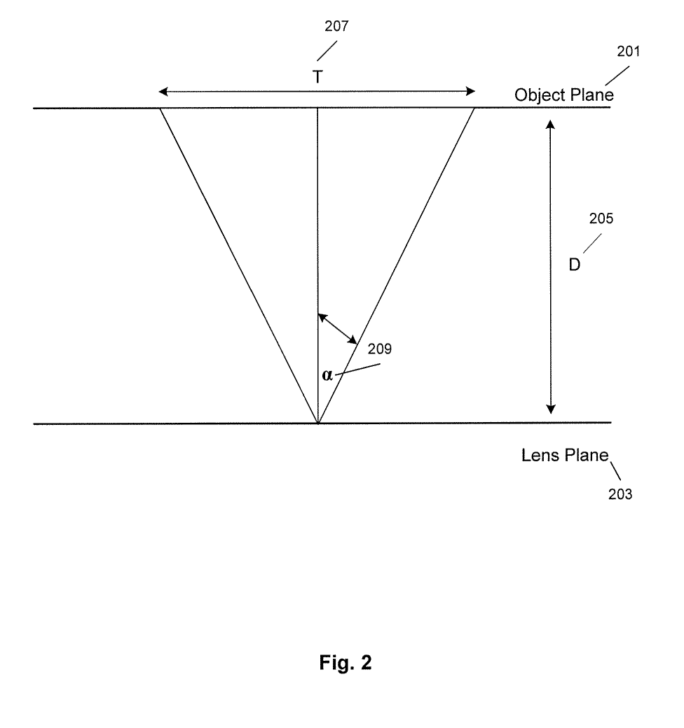

Shown in FIG. 2 is an exemplary depiction according to various embodiments of the present invention including object plane 201 of the object, lens plane 203 of the capture unit, distance D 205 between the object plane and the lens plane, measure of the portion of the object plane of the object that is projected on to the capture unit T 207, and image capture opening angle α 209. It is noted that, in various embodiments, D might be taken to be equivalent to and/or to be an approximation of the distance between the device and the object. α might, in various embodiments, be considered to be constant for a particular capture unit and/or for a particular zoom factor (e.g., a current zoom factor).

Via, for instance, FIG. 2 it can be seen that:

D=T/2·tan(α)

Then, bearing in mind the above-discussed relation:

Δp=d/T,

distance D can be computed as:

D=d/2·tan(α)·Δp.

Accordingly, for example, distance D might be calculated (step 107) (e.g., by the device) when the amount by which the device moves d, the image capture opening angle α, and the relative object translocation value Δp are known. It is noted that, in various embodiments, distance D might be computed for each of one or more of multiple objects in captured images (e.g., for each of one or more objects in a scene).

As an illustrative example, in the case where Δp was 0.1, d was 0.2 meters, and α was 45°, D might be calculated (e.g., by the device) to be 1 meter. Thus, in various embodiments, the distance between the device and the object could be taken to be 1 meter.

It is noted that, in various embodiments, the distance between the device and the object might, alternately or additionally, be considered (e.g., by the device) to be proportional to the quotient of the amount by which the device moves and the number of pixels that an object has translocated, and/or the distance between the device and the object might be taken to be proportional to the quotient of the amount by which the device moves and the relative object translocation value. The nature of such proportionality might, in various embodiments, be determined via analysis (e.g., optical and/or trigonometric analysis) and/or experimentation. The determination of the nature of the proportionality might, for instance, involve the determination of one or more proportionality factors.

It is noted that, in various embodiments, various of the distance determination operations discussed herein as being performed, for instance, by the device might, alternately or additionally, be performed by a server, base station, and/or other computer remote from the device (e.g., as one or more services).

For example, in various embodiments the device might provide to such a server, base station, and/or other computer one or more images (e.g., one or more images captured as discussed above), indication of the total number of pixels of the capture unit of the device (e.g., the total number of pixels in the dimension in which the object translocated), accelerometer output, and/or indication of the image capture opening angle. In various embodiments the server, base station, and/or other computer might, perhaps in a manner analogous to that discussed above, employ such in computing distance. Moreover, in various embodiments the server, base station, and/or other computer might provide the computed distance to the device.

It is noted that, in various embodiments, communication between the device and the server, base station, and/or other computer (e.g., for sending and/or receipt of images, accelerometer output, and/or computed distance) might, for instance, involve the use of Bluetooth (e.g., IEEE 802.15.1 Bluetooth), IEEE 802.11b. IEEE 802.11g, IEEE 802.11n, General Packet Radio Service (GPRS), Universal Mobile Telecommunications Service (UMTS), Global System for Mobile Communications (GSM), Simple Object Access Protocol (SOAP), Java Messaging Service (JMS), Remote Method Invocation (RMI), Remote Procedure Call (RPC), sockets, and/or pipes.

It is further noted that, in various embodiments, the server, base station, and/or other computer might not receive from the device indication of the total number of pixels of the capture unit of the device and/or the image capture opening angle. For instance, the server, base station, and/or other computer might instead access such information by consulting one or more accessible stores (e.g., one or more remote and/or local stores). One or more users, manufacturers, system administrators, and/or service providers might, for example, place in one or more such stores capture unit total number of pixel information and/or image capture opening angle information corresponding to one or more devices.

In various embodiments one or more detection operations and/or one or more compensatory operations might be performed. For example, one or more operations might be performed to detect and/or compensate for rotation (e.g., accidental rotation) that occurs during device movement (e.g., during lateral device movement). Such operations might, for instance, take into account the concept that an object projection being closer to the outside of a capture unit is translocated by a greater amount than an object projection being closer to the center of the capture unit, when the capture unit is rotated.

It is noted that although various aspects have been discussed herein in terms of pixels so as to illustrate by way of example, various aspects may, in various embodiments, be implemented in terms of other than pixels. For instance, in various embodiments various aspects might be implemented in terms of one or more percentages (e.g., one or more percentages of sensor capture dimensions). It is further noted that, in various embodiments, pixel size might be based on a selected sampling rate and/or a needed accuracy.

### Distance Employment Operations

Determined distance between the device and one or more objects might, in various embodiments, be employed in a number of ways.

For example, the device might present to its user (e.g., via a GUI and/or other interface) indication of one or more determined distances. Such functionality might be implemented in a number of ways.

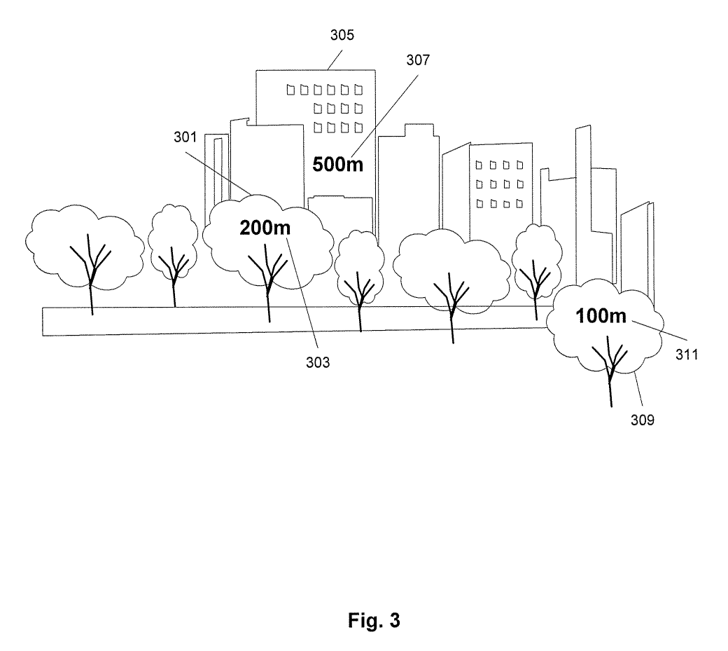

For instance, the device might present its user (e.g., via a GUI and/or other interface) with a depiction of a captured scene, with indication of one or more distances between the device and one or more objects in the scene. Such indication might, in various embodiments, be provided to the user by presenting a captured scene to its user in such a manner that placed over and/or near each of one or more objects in that scene was indication of distance to that object. Shown in FIG. 3 is an exemplary display according to various embodiments of the present invention including object indication 301, distance indication 303, object indication 305, distance indication 307, object indication 309, and distance indication 311.

In this exemplary display, distance indication 303 indicates a distance of 200 meters between the device and the object corresponding to object indication 301 (a tree), distance indication 307 indicates a distance of 500 meters between the device and the object corresponding to object indication 305 (a building), and distance indication 311 indicates a distance of 100 meters between the device and the object corresponding to object indication 309 (a tree). Although distance is discussed here in terms of meters so as to illustrate by way of example, a variety of measurement units and measurement systems might, in various embodiments, be employed.

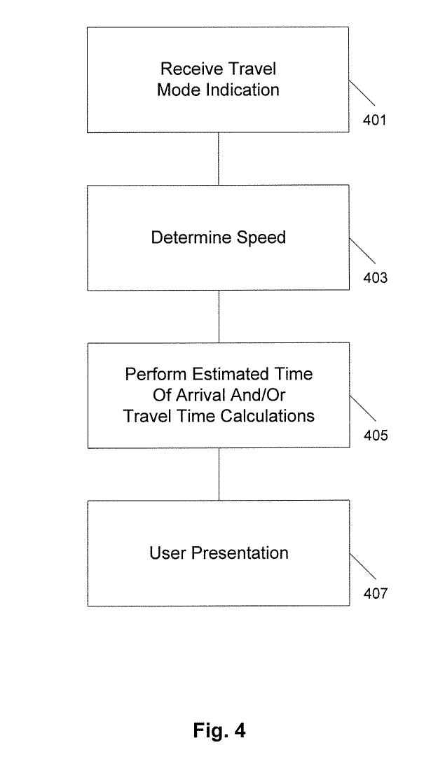

With respect to FIG. 4 it is noted that, as another example, the device might present to its user indication of one or more estimated times of arrival at, and/or travel times to, one or more objects for which distances were determined (step 407). Such presentation might, for example, be performed in a manner analogous to that discussed above. Accordingly, for instance, the user might be presented with a depiction of a captured scene with indication of one or more estimated times of arrival at, and/or travel times to, one or more objects in the scene, the user, in various embodiments, being further presented with one or more distances between the device and one or more objects in the scene.

The device might, in various embodiments, receive from its user (e.g., via a GUI and/or other interface) indication of the speed at which the user planned to travel to one or more objects, and/or indication of a travel mode (e.g., walking, jogging, and/or motor vehicle) that the user planed to employ to travel to one or more of the objects.

The device might, for instance, employ such a received planned speed for travel to an object in conjunction with a determined distance to that object in order to calculate an estimated time of arrival at, and/or travel time to, that object. It is noted that, in various embodiments, in the case where the device receives indication of a travel mode (step 401), the device might determine a speed corresponding to that travel mode (step 403). The device might then, for instance, employ that determined speed in performing estimated time of arrival and/or travel time calculations (step 405). The device might determine a speed corresponding to a travel mode in a number of ways. For instance, the device might consult one or more accessible stores (e.g., one or more remote and/or local stores). As an illustrative example, the device might determine a speed of 3.5 kilometers per hour to correspond to walking.

As yet another example, the device might employ determined distance in one or more focusing operations. For instance, the device might employ the determined distance to an object in selecting an appropriate focus level. The device might then, for example, employ the selected focus level in image capture.

It is noted that, in various embodiments, various of the distance employment operations discussed herein as being performed, for instance, by the device might, alternately or additionally, be performed by a server, base station, and/or other computer remote from the device (e.g., as one or more services). For instance, such a server, base station, and/or other computer might calculate one or more estimated times of arrival and/or travel times.

It is further noted that, in various embodiments, communication between the device and the server, base station, and/or other computer (e.g., for sending and/or receipt of estimated times of arrival and/or travel times) might, for instance, involve the use of Bluetooth, IEEE 802.11b. IEEE 802.11g. IEEE 802.11n, GPRS, UMTS, GSM, SOAP, JMS, RMI, RPC, sockets, and/or pipes.

In various embodiments, user presentation might not deal with presentation of one or more distances, and/or might deal with more than presentation of one or more distances. For example, the user might receive indication of one or more headings. Such heading presentation might, for instance, be in conjunction with presentation of one or more estimated times of arrival and/or travel times (e.g., of the sort discussed above), and/or in conjunction with presentation of one or more positions (e.g., of one or more objects for which distances were determined). Such positions might, for example, be conveyed in terms of one or more coordinate systems (e.g., in terms of latitude and longitude).

In various embodiments, one or more three-dimensional models might be derived from one or more two-dimensional scenes via distance determination (e.g., of the sort discussed herein). The device might, for instance, create new views on the scenes and/or place virtual objects into the scenes. Placement of virtual objects, and/or corresponding user presentation of placed virtual objects, might in various embodiments allow for occlusion and/or uncovering of virtual objects with respect to actual objects, and/or vice versa.

Functionality might, in various embodiments, be provided to deal with scenarios in which an object for which distance determination is to be performed is, and/or comes to be, blocked by another object (e.g., a foreground object). Such a situation might, for instance, arise where the object for which distance determination is to be performed becomes hidden after moving behind another object, and/or where the object for which distance determination is to be performed becomes hidden after another object moves in front of it. Such functionality might be implemented in a number of ways. For example, one or more three-dimensional models (e.g., of the sort discussed above) might be employed.

It is noted that, in various embodiments user presentation might not occur.

### Hardware and Software

Various operations and/or the like described herein may, in various embodiments, be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, telephone, communication device, node, and/or the like, a server, a network access point, a network multicast point, a network device, a set-top box, a personal video recorder (PVR), a game console, a portable game device, a portable audio device, a portable media device, a portable video device, a television, a digital camera, a digital camcorder, a Global Positioning System (GPS) receiver, a wireless personal server, or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or .Net.

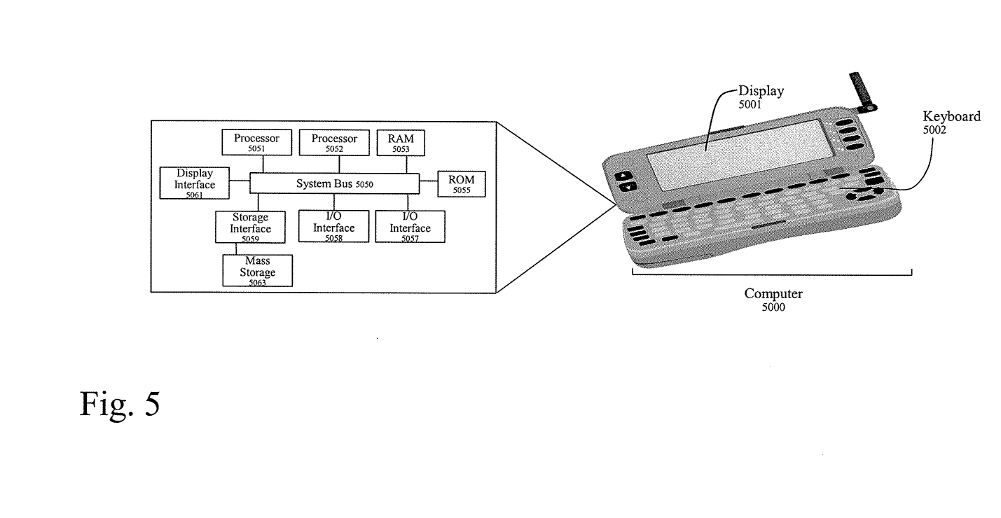

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 5 is an exemplary computer employable in various embodiments of the present invention. Exemplary computer 5000 includes system bus 5050 which operatively connects two processors 5051 and 5052, random access memory 5053, read-only memory 5055, input output (I/O) interfaces 5057 and 5058, storage interface 5059, and display interface 5061. Storage interface 5059 in turn connects to mass storage 5063. Each of I/O interfaces 5057 and 5058 may, for example, be an Ethernet, IEEE 1394, IEEE 1394b, IEEE 802.11a, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16x, IEEE 802.20, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Global System for Mobile Communications (GSM), Code Division Multiple Access 2000 (CDMA2000), DVB-H (Digital Video Broadcasting: Handhelds), IrDA (Infrared Data Association), and/or other interface.

Mass storage 5063 may be a hard drive, optical drive, a memory chip, or the like. Processors 5051 and 5052 may each be a commonly known processor such as an IBM or Freescale PowerPC, an AMD Athlon, an AMD Opteron, an Intel ARM, an Intel XScale, a Transmeta Crusoe, a Transmeta Efficeon, an Intel Xenon, an Intel Itanium, an Intel Pentium, an Intel Core, or an IBM, Toshiba, or Sony Cell processor. Computer 5000 as shown in this example also includes a touch screen 5001 and a keyboard 5002. In various embodiments, a mouse, keypad, and/or interface might alternately or additionally be employed. Computer 5000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Comega according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed. It is additionally noted that, in various embodiments, remote communication among software modules may occur. Such remote communication might, for example, involve Simple Object Access Protocol (SOAP), Java Messaging Service (JMS), Remote Method Invocation (RMI), Remote Procedure Call (RPC), sockets, and/or pipes.

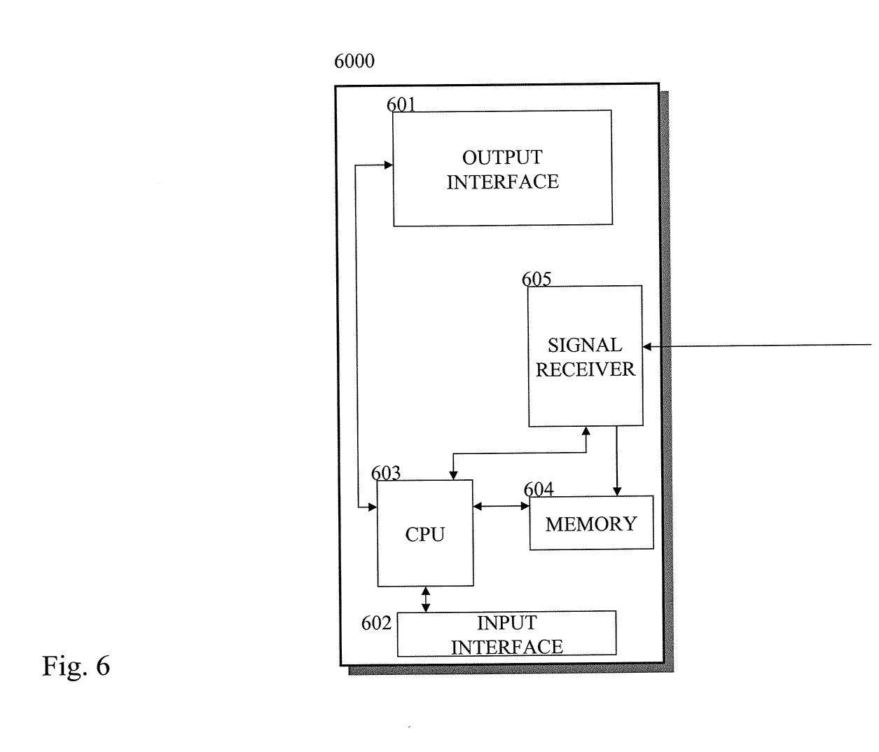

Shown in FIG. 6 is a block diagram of a terminal, an exemplary computer employable in various embodiments of the present invention. In the following, corresponding reference signs are applied to corresponding parts. Exemplary terminal 6000 of FIG. 6 comprises a processing unit CPU 603, a signal receiver 605, and a user interface (601, 602). Signal receiver 605 may, for example, be a single-carrier or multi-carrier receiver. Signal receiver 605 and the user interface (601, 602) are coupled with the processing unit CPU 603. One or more direct memory access (DMA) channels may exist between multi-carrier signal terminal part 605 and memory 604. The user interface (601, 602) comprises a display and a keyboard to enable a user to use the terminal 6000. In addition, the user interface (601, 602) comprises a microphone and a speaker for receiving and producing audio signals. The user interface (601, 602) may also comprise voice recognition (not shown).

The processing unit CPU 603 comprises a microprocessor (not shown), memory 604, and possibly software. The software can be stored in the memory 604. The microprocessor controls, on the basis of the software, the operation of the terminal 6000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 6, alternatively, middleware or software implementation can be applied. The terminal 6000 can, for instance, be a hand-held device which a user can comfortably carry. The terminal 6000 can, for example, be a cellular mobile phone which comprises the multi-carrier signal terminal part 605 for receiving multicast transmission streams. Therefore, the terminal 6000 may possibly interact with the service providers.

It is noted that various operations and/or the like described herein may, in various embodiments, be implemented in hardware (e.g., via one or more integrated circuits). For instance, in various embodiments various operations and/or the like described herein may be performed by specialized hardware, and/or otherwise not by one or more general purpose processors. One or more chips and/or chipsets might, in various embodiments, be employed. In various embodiments, one or more Application-Specific Integrated Circuits (ASICs) may be employed.

### Ramifications and Scope

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
determining imaged translocation of one or more objects;
determining translocation of a device; and
determining one or more distances between one or more of the objects and the device, wherein the imaged translocation and the translocation of the device are taken into account.

2. The method of claim 1, wherein output of one or more motion sensors is employed in determination of the translocation of the device.

3. The method of claim 1, wherein determination of the translocation of the device comprises determining imaged translocation of one or more objects with known distances.

4. The method of claim 1, wherein determination of the imaged translocation comprises determination of one or more pixel quantities.

5. The method of claim 1, wherein determination of the one or more distances further takes into account an image capture opening angle.

6. The method of claim 1, further comprising instructing a user to translocate the device.

7. The method of claim 1, further comprising displaying to a user one or more of the distances.

8. The method of claim 1, further comprising employing one or more of the distances in one or more focus operations.

9. The method of claim 1, further comprising employing one or more of the distances in determining one or more estimated times of arrival at one or more of the objects.

10. A method, comprising:
receiving, from a remote device, one or more captured images; and
determining one or more distances between the remote device and one or more objects of the one or more captured images.

11. The method of claim 10, further comprising receiving, from the remote device, an image capture opening angle.

12. The method of claim 10, further comprising receiving, from the remote device, a total number of pixels of a capture unit of the remote device.

13. The method of claim 10, further comprising dispatching, to the remote device, one or more of the distances.

14. The method of claim 10, further comprising determining imaged translocation of one or more of the objects.

15. The method of claim 10, further comprising determining translocation of the remote device.

16. The method of claim 15, further comprising receiving, from the remote device, motion sensor output, wherein some or all of the motion sensor output is employed in determination of the translocation of the remote device.

17. The method of claim 15, wherein determination of the translocation of the remote device comprises determining imaged translocation of one or more objects with known distances.

18. The method of claim 10, further comprising employing one or more of the distances in determining one or more estimated times of arrival at one or more of the objects.

19. An apparatus, comprising:
a memory having program code stored therein; and
a processor disposed in communication with the memory for carrying out instructions in accordance with the stored program code;
wherein the program code, when executed by the processor, causes the processor to perform:
determining imaged translocation of one or more objects;
determining translocation of the apparatus; and
determining one or more distances between one or more of the objects and the apparatus, wherein the imaged translocation and the translocation of the apparatus are taken into account.

20. The apparatus of claim 19, wherein output of one or more motion sensors is employed in determination of the translocation of the apparatus.

21. The apparatus of claim 19, wherein determination of the translocation of the apparatus comprises determining imaged translocation of one or more objects with known distances.

22. The apparatus of claim 19, wherein determination of the imaged translocation comprises determination of one or more pixel quantities.

23. The apparatus of claim 19, wherein determination of the one or more distances further takes into account an image capture opening angle.

24. The apparatus of claim 19, wherein the processor further performs instructing a user to translocate the apparatus.

25. The apparatus of claim 19, wherein the processor further performs displaying to a user one or more of the distances.

26. The apparatus of claim 19, wherein the processor further performs employing one or more of the distances in one or more focus operations.

27. The apparatus of claim 19, wherein the processor further performs employing one or more of the distances in determining one or more estimated times of arrival at one or more of the objects.

28. The apparatus of claim 19, further comprising:
a network interface disposed in communication with the processor,
wherein the apparatus is a wireless node.

29. An apparatus, comprising:
a memory having program code stored therein; and
a processor disposed in communication with the memory for carrying out instructions in accordance with the stored program code;
wherein the program code, when executed by the processor, causes the processor to perform:
receiving, from a remote device, one or more captured images; and
determining one or more distances between the remote device and one or more objects of the one or more captured images.

30. The apparatus of claim 29, wherein the processor further performs receiving, from the remote device, an image capture opening angle.

31. The apparatus of claim 29, wherein the processor further performs receiving, from the remote device, a total number of pixels of a capture unit of the remote device.

32. The apparatus of claim 29, wherein the processor further performs dispatching, to the remote device, one or more of the distances.

33. The apparatus of claim 29, wherein the processor further performs determining imaged translocation of one or more of the objects.

34. The apparatus of claim 29, wherein the processor further performs determining translocation of the remote device.

35. The apparatus of claim 34, wherein the processor further performs receiving, from the remote device, motion sensor output, wherein some or all of the motion sensor output is employed in determination of the translocation of the remote device.

36. The apparatus of claim 34, wherein determination of the translocation of the remote device comprises determining imaged translocation of one or more objects with known distances.

37. The apparatus of claim 29, wherein the processor further performs employing one or more of the distances in determining one or more estimated times of arrival at one or more of the objects.

38. An article of manufacture comprising a computer readable medium containing program code that when executed causes an apparatus to perform:
determining imaged translocation of one or more objects;
determining translocation of the apparatus; and
determining one or more distances between one or more of the objects and the apparatus, wherein the imaged translocation and the translocation of the apparatus are taken into account.

39. An article of manufacture comprising a computer readable medium containing program code that when executed causes an apparatus to perform:
receiving, from a remote device, one or more captured images; and
determining one or more distances between the remote device and one or more objects of the one or more captured images.
